(19) United States
(12) Patent Application Publication
(10) Pub. No.: US 2010/0028701 A1
(43) Pub. Date: Feb. 4, 2010

(54) Free-radically curable composition comprising polymerizable monomer and free-radical initiator

(75) Inventors: Ria De Cooman, Arni (CH); Steffen Maier, Wettingen (CH); Peter Gimmnich, Konstanz (DE)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/311,743

(22) PCT Filed: Oct. 30, 2007
(86) PCT No.: PCT/EP2007/061645

§ 371 Date: Apr. 24, 2009

(30) Foreign Application Priority Data
Oct. 30, 2006 (EP) 06123168.4

(51) Int. Cl. B32B 27/36; C08F 20/00; B32B 37/12; B05D 3/02

(52) U.S. Cl. 428/480; 526/270; 522/113; 522/33; 522/68; 522/64; 522/18; 156/327; 427/385.5

(57) ABSTRACT

A single- or multiple-component, free-radically curable composition having at least one free-radically polymerizable monomer of the formula (I) and at least one free-radical initiator. These compositions are suitable as adhesives or sealants and also as coverings. Both before and after curing they have a very low odour, and after curing they possess excellent mechanical qualities in tandem with effective adhesion, to various materials such as plastics, and are therefore suitable for use in areas that are closed or difficult to aerate.

### FIELD OF THE INVENTION

The invention relates to the field of free-radically polymerizable monomers.

### BACKGROUND ART

Free-radically polymerizable monomers, more particularly α,β-unsaturated monomers, have been known and in use for a long time. They have long been used as coatings, adhesives and sealants and are polymerized by light, more particularly by UV light, or by free radicals formed thermally.

There is a broad commercially available range of such monomers, more particularly of (meth)acrylate monomers for free-radical polymerization.

On account of the requirements there is a great need for monomers which have a low intrinsic odour and which after curing exhibit good mechanical properties and more particularly a high glass transition temperature and also good adhesion to a broad range of substrates, more particularly plastics.

R. F. Talipov in Russian Journal of Organic Chemistry, Vol. 29, No. 7, 1993, 1205-1207 discloses the preparation of various hydroxytetrahydrofuryl esters, including the ester of acrylic acid and methacrylic acid, and discloses how 3-hydroxytetrahydrofuran and its derivatives are of interest as biologically active compounds, more particularly in relation to the AIDS virus.

### SUMMARY OF THE INVENTION

It is an object of the present invention, therefore, to provide free-radically curable compositions which have a low intrinsic odour and which, after curing, have good mechanical properties, and more particularly a high glass transition temperature, and good adhesion to a broad range of substrates, more particularly plastics.

Surprisingly it has now been found that compositions according to claim 1 which comprise specific esters of 3-hydroxytetrahydrofuran achieve this object.

These compositions, both before and after curing, have a very low odour and, after curing, possess excellent mechanical properties in tandem with high adhesion, more particularly to plastics.

These compositions can be employed more particularly as adhesives or sealants or as a coating and can be polymerized thermally or by means of electromagnetic radiation.

Another aspect of the invention is a method of adhesive bonding according to claim 21 or of coating according to claim 22, and also resultant adhesively bonded or coated articles according to claim 23 or 25.

The invention finally also relates to the use of the specific ester of 3-hydroxytetrahydrofuran of the formula (I) as a monomer for applications, more particularly as an adhesive, which, after curing of the monomer, exhibit an operating temperature of higher than 60° C., more particularly of higher than 80° C.

On account of the low intrinsic odour of this monomer it is especially suitable for use in accordance with claim 28 for applications in closed or difficult-to-ventilate interiors.

### EMBODIMENTS OF THE INVENTION

The present invention provides a single- or multiple-component, free-radically curable composition which comprises at least one free-radically polymerizable monomer of the formula (I) and at least one free-radical initiator.

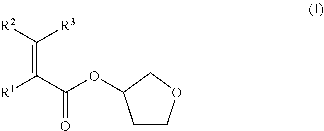

In this formula R¹ is H, CH₃, CH₂—CH₃ or CH₂COOR⁴.
R² is H, CH₃, CH₂—CH₃, phenyl, CH═CH—CH₃, COOR⁴ or CH₂COOR⁴.
R³ is H, CH₃, COOR⁴ or CH₂COOR⁴.
Finally R⁴ is H, alkyl, cycloalkyl, phenyl or

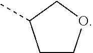

If R⁴ is an alkyl group, methyl, ethyl, n-propyl, isopropyl, n-butyl, sec-butyl and tert-butyl, and also n-butyl, are particularly preferred for it.

The free-radically polymerizable monomer of the formula (I) can be prepared by esterifying 3-hydroxytetrahydrofuran and the corresponding carboxylic acid.

Examples of suitable such carboxylic acids are methacrylic acid, acrylic acid, crotonic acid, itaconic acid, tiglic acid, trans-2-pentenoic acid, cinnamic acid, senecic acid, sorbic acid, fumaric acid, maleic acid, mesaconic acid, glutaconic acid and citraconic acid. Additionally suitable are partly esterified dicarboxylic or polycarboxylic acids in which not all of the carboxylic acid groups are esterified with 3-hydroxytetrahydrofuran.

The free-radically polymerizable monomer of the formula (I) can also be prepared by reacting 3-hydroxytetrahydrofuran with the corresponding acid halide or acid anhydride. Particularly suitable are the acid halides or acid anhydrides of the carboxylic acids recited above.

One very preferred further possibility for preparing the free-radically polymerizable monomer of the formula (I) lies in the transesterification of an ester of the formula (II)

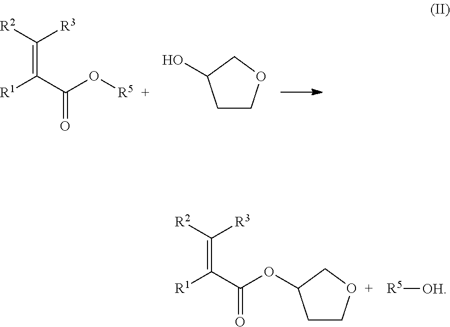

R⁵ here is a C₁-C₆ alkyl radical, more particularly methyl or ethyl. The transesterification takes place under the influence of a catalyst, more particularly a titanate.

Partly esterified monomers of the formula (I) can be prepared in a simple way from anhydrides of a dicarboxylic acid with 3-hydroxytetrahydrofuran. An example of this is the partly esterified monomer of the formula (I′) below, which can be prepared from the reaction with maleic anhydride.

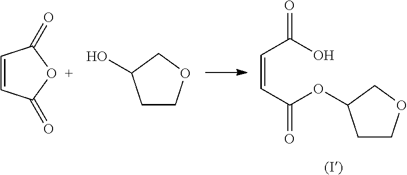

These partly esterified monomers can be esterified further with further alcohols. Depending on the alcohol used it is possible to prepare diesters having two different ester chains.

In one preferred embodiment R²═R³═H and R¹═H or CH₃. CH₃ is preferred in particular. Accordingly the free-radically polymerizable monomer of the formula (I) is more particularly an ester of (meth)acrylic acid, preferably of methacrylic acid.

The 3-hydroxytetrahydrofuran which can be used for preparing the free-radically polymerizable monomer of the formula (I) is available commercially, for example, from ABCR GmbH & Co., Germany, Acros Organics, or from Chemos GmbH, Germany.

There are a number of possible ways of preparing 3-hydroxytetrahydrofuran, an example being from 1,2,4-butanetriol, as disclosed, for example, by Daniele Marton et al., Tetrahedron, Vol. 45, No. 22, 1989,7099 -7108.

The free-radically polymerizable monomer of the formula (I) is notable in particular for a low intrinsic odour, and so it is also possible to formulate the single- or multiple-component, free-radically curable composition with a low intrinsic odour. On account of the low intrinsic odour the monomers of the formula (I) are suitable more particularly for applications in closed interiors that are difficult to ventilate. This is particularly important for the applications as floor covering or photocurable coating material.

Moreover, the compositions with the monomer of the formula (I), after curing, have a particularly high glass transition temperature. Consequently the monomer of the formula (I) is especially suitable for applications, more particularly as an adhesive, which, after the monomer has cured, exhibit an operating temperature of higher than 60° C., more particularly of higher than 80° C.

The monomers of the formula (I) have the great advantages that they are obtainable synthetically very effectively and easily and possess excellent stability to hydrolysis both before and after polymerization. After polymerization, moreover, they also have no tendency towards embrittlement or further crosslinking reactions, of the kind which, in certain other monomers, may take place under the influence of free radicals after crosslinking.

The fraction of the free-radically polymerizable monomer of the formula (I) as a proportion of the single- or multiple-component, free-radically curable composition is preferably between 10% and 99% by weight, more particularly between 30% and 95% by weight.

The single- or multiple-component, free-radically curable composition comprises at least one free-radical initiator. Free-radical initiators are more particularly molecules which, under the influence of heat or of electromagnetic radiation, form free radicals, which then lead to the polymerization of the free-radically polymerizable monomers of the formula (I).

Preferred thermally activatable free-radical initiators are more particularly those which are still sufficiently stable at room temperature but already form free radicals even at a slightly elevated temperature. More particularly the free-radical initiator is a peroxide, a perester or hydroperoxide. Organic peroxides are preferred. Most preferably the free-radical initiator is dibenzoyl peroxide.

Photoinitiators are free-radical initiators which form free radicals under the influence of electromagnetic radiation. More particularly it is a photoinitiator which forms free radicals on irradiation with an electromagnetic radiation of the wavelength of 230 nm to 400 nm. Additionally it is preferably liquid at room temperature.

With particular preference the photoinitiator is selected from the group consisting of α-hydroxyketones, phenylglyoxylates, monoacylphosphines, diacylphosphines, phosphine oxides and mixtures thereof, more particularly from the group consisting of 1-hydroxycyclohexyl phenyl ketone, benzophenone, 2-hydroxy-2-methyl-1-phenylpropanone, methyl phenylglycoxylate, 2-[2-oxo-2-phenylacetoxyethoxy]ethyl hydroxyphenyl acetate, 2-[2-hydroxyethoxy]ethyl hydroxyphenyl acetate, diphenyl(2,4,6-trimethylbenzoyl)phosphine oxide, phenylbis(2,4,6-trimethylbenzoyl)phosphine oxide and mixtures thereof. Photoinitiators of this kind are available commercially, for example, from the IRGACURE and DAROCUR product lines of Ciba Specialty Chemicals.

It has emerged that mixtures of photoinitiators, more particularly the combination of a bisacylphosphine oxide and an α-hydroxyketone, are especially suitable. The most preferred photoinitiators are a mixture of phenylbis(2,4,6-trimethylbenzoyl)phosphine oxide and 2-hydroxy-2-methyl-1-phenylpropanone.

Where the free-radical initiator is a peroxide, a perester or hydroperoxide, it is advantageous for the composition further to comprise at least one tertiary amine or transition metal salt or transition metal complex as catalyst. The effect of the presence of this catalyst is that the free radicals are formed at a lower temperature, more particularly at room temperature. Examples of suitable tertiary amines are N,N-dimethylaniline, N,N-dimethyl-p-toluidine, N,N-diethylaniline, N,N-diethyltoluidine, N,N-bis(2-hydroxyethyl)-p-toluidine, N-ethoxylated p-toluidines, N-alkylmorpholines or mixtures thereof. Particularly suitable transition metal salts or transition metal complexes are, more particularly, those of the metals cobalt, manganese, vanadium and copper.

Preferred catalysts are tertiary amines.

The fraction of the catalyst as a proportion of the single- or multiple-component, free-radically curable composition is preferably between 0.01% and 10% by weight, more particularly between 0.1% and 5% by weight.

The fraction of the free-radical initiator as a proportion of the single- or multiple-component, free-radically curable composition is preferably between 0.01% and 15% by weight, more particularly between 0.5% and 10% by weight.

The composition advantageously comprises at least one further free-radically polymerizable monomer M. This monomer M is more particularly selected from the group consisting of α,β-unsaturated carboxylic acids, esters of α,β-unsaturated carboxylic acids, amides of α,β-unsaturated carboxylic acids, anhydrides of α,β-unsaturated carboxylic acids; α,β-unsaturated dicarboxylic acids, esters of α,β-unsaturated dicarboxylic acids, amides of α,β-unsaturated dicarboxylic acids, anhydrides of α,β-unsaturated dicarboxylic acids; vinyl alcohols or allyl alcohols; vinylcarboxylic esters, allylcarboxylic esters, acrylonitrile and styrene.

More particularly the monomer M is (meth)acrylic acid or (meth)acrylic ester, preferably a methacrylic ester.

Most preferably the further free-radically polymerizable monomer M is selected from the group consisting of 2-hydroxyethyl methacrylate (HEMA), hydroxypropyl methacrylate (HPMA), trimethylcyclohexyl methacrylate (TMCHMA), cyclohexyl methacrylate (CHMA), isobornyl methacrylate (IBMA), tetrahydrofurfuryl methacrylate (THFMA). Particular preference is given to tetrahydrofurfuryl methacrylate (THFMA).

The use of at least one further free-radically polymerizable monomer M in the composition may be advantageous since it allows simple variation of the properties, more particularly the mechanical properties. Moreover a blend of this kind may also be advantageous on grounds of cost. In this context, however, care should be taken to ensure that the positive properties are not too greatly impaired by such a blend. More particular preference is therefore given, as further monomers M, to those which have little or no intrinsic odour before and after curing.

The fraction of the further free-radically polymerizable monomer M, where present, as a proportion of the single- or multiple-component, free-radically curable composition is preferably between 10% and 60% by weight, more particularly between 10% and 40% by weight.

The composition advantageously further comprise at least one metal (meth)acrylate. Suitable metal (meth)acrylate are more particularly metal (meth)acrylate of Ca(II), Mg(II) or Zn(II) which have hydroxyls and/or (meth)acrylic acid or (meth)acrylate as ligand or anion.

Particular preference is given to zinc (meth)acrylate, calcium (meth)acrylate, Zn (OH) (meth)acrylate and magnesium (meth)acrylate.

The fraction of the metal (meth)acrylate, where present, is preferably between 0.1% and 20% by weight, more particularly between 0.5% and 10% by weight.

The composition may contain further additional constituents. Such additional constituents are core-shell polymers, liquid rubbers, organic and inorganic fillers, dyes, pigments, inhibitors, UV and heat stabilizers, antistats, flame retardants, biocides, plasticizers, waxes, flow control agents, adhesion promoters, thixotropic agents and further, raw materials and additives that are known to a person skilled in the art.

Fillers are used in the composition preferably in an amount of 10%-60% by weight.

Suitable polymerization inhibitors are more particularly hydroquinones, more particularly hydroquinone and methylhydroquinones, or tert-butyl-p-cresol.

Particularly suitable additional constituents besides catalysts are more particularly core-shell polymers and liquid rubbers.

Core-shell polymers are composed of an elastic core polymer and a rigid shell polymer. Core-shell polymers that are suitable more particularly are composed of a core of crosslinked elastic acrylate or butadiene polymer which has been grafted onto a rigid shell of a rigid thermoplastic polymer.

Particularly suitable core-shell polymers are those which swell but do not dissolve in the organic (meth)acrylate.

Preferred core-shell polymers are those known as MBS polymers, available commercially under the trade name Clearstrength™ from Atofina or Paraloid™ from Rohm and Haas. The core-shell polymers are used preferably in an amount of 5% to 40% by weight, more particularly of 5%-25% by weight, based on the composition.

Liquid rubbers that are suitable are more particularly butadiene/acrylonitrile copolymer-based liquid rubbers or polyurethane-based liquid rubbers. The liquid rubbers preferably contain unsaturated double bonds.

Particularly suitable liquid rubbers are firstly vinyl-terminated butadiene/acrylonitrile copolymers, of the kind available commercially under the product series Hycar® VTBNX from BFGoodrich®, or from Noveon.

Considered secondly to be particularly suitable liquid rubbers are (meth)acrylate-terminated polyurethane polymers. Polymers of this kind may be prepared from polyols and polyisocyanates with formation of isocyanate-functional polyurethane prepolymers and subsequent reaction with hydroxyalkyl (meth)acrylates.

Preferred isocyanate-functional polyurethane prepolymers are the reaction product of a polyisocyanate, more particularly a diisocyanate, and a polyol in a ratio of isocyanate group equivalents to hydroxyl group equivalents of greater than 1. Accordingly adducts of the type OCN—xx—NHCO—O—yy—O—CONH—xx—NCO are also considered to be polyurethane prepolymers in this context, where xx stands for a diisocyanate without NCO groups and yy stands for a diol without OH groups.

In principle for this purpose it is possible to use any polyol HO—R—(OH)_{q} with q≧1, R being a polymer backbone with heteroatoms in the backbone or as side chains.

Preferred polyols are polyols which are selected from the group consisting of polyoxyalkylene polyols, also called “polyether polyols”, polyester polyols, polycarbonate polyols and mixtures thereof. Preferred polyols are diols. The most preferred diols are polyoxyethylene diols or polyoxypropylene diols or polyoxybutylene diols.

The polyoxyalkylene polyols may have a low degree of unsaturation (measured by ASTM D-2849-69 and reported as milliequivalents of unsaturation per gram of polyol (meq/g)), as prepared, for example, by means of what are known as double metal cyanide complex catalysts (DMC catalysts), or else may have a high degree of unsaturation, in that case being prepared, for example, by means of anionic catalysts such as NaOH, KOH, CsOH or alkali metal alkoxides.

The use of polyoxyalkylene polyols with a low degree of unsaturation, more particularly of less than 0.01 meq/g, is preferred for polyols having a molecular weight of ≧2000.

In principle it is possible to use any polyisocyanates having two or more isocyanate groups.

Examples that may be mentioned include 2,4- and 2,6-tolylene diisocyanate (TDI) and mixtures thereof, 4,4′-diphenylmethane diisocyanate (MDI), any isomers of diphenylmethane diisocyanate, 1,3- and 1,4-phenylene diisocyanate, 2,3,5,6-tetramethyl-1,4-diisocyanatobenzene, 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,12-dodeca-methylene diisocyanate, cyclohexane 1,3- and -1,4-diisocyanate and any mixtures of these isomers with one another, 1-isocyanato-3,3,5-trimethyl-5-isocyanatomethylcyclohexane (i.e. isophorone diisocyanate or IPDI), perhydro-2,4′- and -4,4′-diphenylmethane diisocyanate (HMDI), 1,4-diisocyanato-2,2,6-trimethylcyclohexane (TMCDI), m- and p-xylylene diisocyanate (XDI), 1,3- and 1,4-tetramethylxylylene diisocyanate (TMXDI), 1,3- and 1,4-bis-(isocyanatomethyl)cyclohexane, any oligomers or polymers of the abovementioned isocyanates and also any mixtures of the stated isocyanates with one another. Preferred polyisocyanates are MDI, TDI, HDI, IPDI and their mixtures with one another. Most preferred are IPDI and HDI and a mixture thereof.

The isocyanate-terminated prepolymers prepared from the polyols and polyisocyanates are reacted with (meth)acrylic esters which contain hydroxyl groups. Preferred (meth)acrylic esters which contain hydroxyl groups are hydroxyethyl (meth)acrylate or hydroxypropyl (meth)acrylate. The two reactants are reacted conventionally with one another, typically in a stoichiometric excess of the (meth)acrylic ester which contains hydroxyl groups.

The preferred (meth)acrylate-terminated polyurethane polymer is the reaction product of an IPDI/polypropylene glycol polyurethane prepolymer or of an HDI/polypropylene glycol polyurethane prepolymer with hydroxyethyl (meth)acrylate or with hydroxypropyl (meth)acrylate.

The liquid rubbers are used preferably in an amount of 5% to 40% by weight, based on the composition.

In one preferred embodiment the single- or multiple-component, free-radically curable composition comprises
at least one free-radically polymerizable monomer of the formula (I), more particularly in an amount of 20%-50% by weight
at least one free-radical initiator, more particularly a peroxide, more particularly in an amount of 0.1%-10% by weight
at least one catalyst, more particularly in an amount of 0.1%-5% by weight
at least one filler, more particularly in an amount of 10%-60% by weight
if desired, at least one further free-radically polymerizable monomer M, more particularly in an amount of 10%-40% by weight
if desired, at least one metal (meth)acrylate, more particularly in an amount of 0.5%-10% by weight
if desired, at least one core-shell polymer, more particularly in an amount of 5%-25% by weight.

The single- or multiple-component, free-radically curable composition may be one component—that is, it is composed of one component.

A one-component composition of this kind polymerizes to a polymer under the influence of an energy which acts when required. In the absence of or with shielding from a source of such energy, the composition is storage-stable, or at least conditionally storage-stable. The energy which acts when required may be electromagnetic radiation or heat. This action may be continuous or sudden, in the form of a flash or pulse, for example.

This may on the one hand be a pulse of great heat, for example via a flame or heated gas or a heated metal. The source of an electromagnetic radiation may be different. In particular it is sunlight or an artificial light source such as laser, UV lamp, IR sources or microwave sources. Preference is given to sources which generate a radiation situated in the wavelength range from 230 nm to 400 nm. More, particular preference is given to UV lasers and medium- or high-pressure mercury or xenon lamps of the kind employed for UV curing.

Shielding from a source of such energy may be effected via storage in a dark place or in a pack which is impervious to light, such as in an aluminium canister, for example, or in a cooled location, such as in a refrigerator or freezer, for example.

One-component compositions are especially advantageous for the case in which the free-radical initiator is a photoinitiator. Compositions of this kind are advantageously storable at room temperature in the absence of light and are cured in particular by means of a light source.

One-component compositions can be employed in particular as photocurable coating materials.

The single- or multiple-component, free-radically curable composition may be two-component, being composed of a first component K1 and a second component K2. In this case the first component K1 comprises at least the free-radically polymerizable monomer of the formula (I) and, if desired, the tertiary amine or the transition metal salt or the transition metal complex as catalyst, and the second component K2 comprises at least the peroxide, the perester or the hydroperoxide as free-radical initiator.

In one embodiment the first component K1 comprises at least the free-radically polymerizable monomer of the formula (I) and at least the peroxide, the perester or the hydroperoxide as free-radical initiator, and the second component K2 comprises the tertiary amine or the transition metal salt or the transition metal complex as catalyst. This embodiment is especially advantageous when the cured composition after polymerization is to have low film thicknesses.

Where necessary the two components are mixed together and polymerize. The two components are storage-stable or conditionally storage-stable separately from one another. It is advantageous if the two components do not have to be stored chilled.

Mixing may take place manually by means of a mixing means, such as a spatula, or via a static or dynamic mixer.

The single- or multiple-component, free-radically curable composition has a great diversity of possible uses. More particularly it can be used as a coating, sealant or adhesive. Moreover, the compositions can be used for producing mouldings, such as optical lenses, for example.

Coatings include, in particular, varnishes or coverings. One particularly important field of use is that of photocurable coating materials, of the kind used for the coating of metals or plastics or for the coating of paper or plastics. Coverings include, in particular, floor coverings.

A further preferred application as a coating is that of what are called primers. A primer is a coating on a substrate, with a further material being applied to the primer, and has an adhesion promoter function.

In the case of coating, a method which is employed in particular is one which comprises the following steps:
i′) applying a single- or multiple-component, free-radically curable composition as described above to a substrate S1
ii′) curing the single- or multiple-component, free-radically curable composition.

Step i′) is preferably followed by a step i″) of irradiating the composition with an electromagnetic radiation. The possibilities and preferred embodiments of the substrate S1 correspond to those mentioned in the context of the method of adhesive bonding that is described below.

The result of this method is a coated article.

The single- or multiple-component, free-radically curable composition, in particular in the form of a two-component composition, is more preferably used as an adhesive or sealant.

In the adhesive bonding of two substrates S1 and S2, use is made more particularly of a method which comprises the following steps:
i) applying a single- or multiple-component, free-radically curable composition as described above to a substrate S1;
ii) contacting the applied composition with a second substrate S2 within the open time;
or
ia) applying a single- or multiple-component, free-radically curable composition as described above to a substrate S1;
ib) applying a single- or multiple-component, free-radically curable composition as described above to a substrate S2;
iia) joining the two substrates S1 and S2, with composition applied, within the open time;
the second substrate S2 being composed of the same material as or a different material from the substrate S1; and step i), or ia) and ib), in the case of a multiple-component composition, being preceded by a step I) of at least partly mixing the plurality of components.

The substrate S1 and/or S2 may be diverse in nature. It has emerged, however, that the compositions exhibit excellent adhesion in particular even to plastics. Preferably, therefore, at least one of the substrates, S1 or S2, is a plastic, more particular a plastic selected from the group consisting of PVC, ABS, polycarbonate, poly(methyl (meth)acrylate) (PMMA), polyester, polyamide, modified polyethylene or propylene, such as air or low-pressure plasma-pretreated polyethylene or polypropylene; polystyrene and copolymers of styrene, such as ASA and SAN.

The substrate may additionally be a fibre material, more particularly paper or card, especially printed paper; or a metallic material, more particularly aluminium, iron, copper or alloys thereof, such as steel, for example; or a computer board or printed circuit, or a mineral substrate, more particularly glass, glass ceramic, concrete or masonry.

The substrate may be a sheet or a thick-layer element.

The substrates may be pretreated where necessary before the composition is applied. Pretreatments of this kind encompass, in particular, physical and/or chemical cleaning methods, examples being abrading, sandblasting, brushing or the like, or treatment with cleaners or solvents, or the application of an adhesion promoter, an adhesion-promoter solution or a primer.

This method results in an adhesively bonded article. Such articles represent preferably a means of transport, more particularly a car, bus, lorry, rail vehicle, a boat or an aircraft, or industrially manufactured articles or interior fitments.

The single- or multiple-component composition described finds application more particularly in industrial manufacture, especially that of vehicles and articles of everyday use, and also in building, especially in construction and civil engineering.

Examples of such are houses, glass facades, windows, baths, bathrooms, kitchens, roofs, bridges, tunnels, roads, cars, lorries, rail vehicles, buses, boats, mirrors, glazing sheets, tubs, white goods, household appliances, dishwashers, washing machines and modules for installation therein or thereon.

In a further aspect the invention provides a cured composition which is obtained from a single- or multiple-component, free-radically curable composition, as described above, by a curing operation.

### Examples

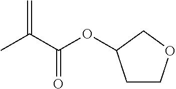

Preparation of (3-THF-MA)

10 g of 3-hydroxytetrahydrofuran and 22.7 g of methyl methacrylate were introduced. Added to this mixture was tetra-n-butyl titanate as a catalyst, and the reaction mixture was heated to 90° C. The methanol formed was removed by distillation on a 20 cm Vigreux column. The mixture was heated at 150° C. for 4 h and then worked up.

For working up, the batch was admixed with 200 ml of water and the organic phase was separated off. The aqueous phase was extracted twice with hexane. Thereafter the organic phase was dried over MgSO₄ and concentrated after filtration. This gave 16.51 g of crude 3-hydroxyTHFMA product.

Following distillation under a high vacuum (0.06 bar; 50° C.), a yield of 13.6 g of 3-hydroxytetrahydrofuryl ester of methacrylic acid (“3-THF-MA”) was obtained (76% of theory).

IR spectrum (ATR, Perkin Elmer ATR-FTIR) [cm^{-1]: 2957} (m), 2983 (m), 2866 (m), 1714 (s), 1636 (m), 1451 (m), 1381 (w), 1354 (w), 1315 (m), 1295 (s), 1159 (s), 1110 (m), 1082(s), 1010 (m), 976 (m), 940 (m), 911 (m), 815 (m), 732 (w), 653 (w). (w=weak, m=moderate, s=strong)

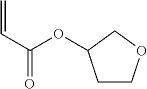

Preparation of (3-THF-A)

Preparation and purification take place in a manner analogous to that for 3-THF-MA, the methyl methacrylate being replaced by the stochiometrically equivalent use of methyl acrylate. This gives 3-hydroxytetrahydrofuryl ester of acrylic acid (“3-THF-A”).

IR spectrum (ATR, Perkin Elmer ATR-FTIR) [cm^{-1]: 2985} (m), 2867 (m), 1719 (s), 1635 (m), 1619 (m), 1440 (m), 1408 (s), 1352 (w), 1296 (s), 1272 (s), 1186 (s), 1110 (m), 1081(s), 1047 (s), 971 (s), 910 (m), 862 (w), 810 (m), 740 (w), 662 (w). (w=weak, m=moderate, s=strong)

Exemplary Compositions as Photocurable Coating Material

The compositions in accordance with the details in Table 1 were prepared. The compositions were applied to a glass plate (float glass, Rocholl Deutschland, tin side downwards) by means of a rounded doctor blade (black (4)) in a film thickness of 40 μm and irradiated with a UV lamp (Dr Hönle Uvaprint 100 CV2, 200 W/cm², gallium-doped Hg lamp, maxima at 300 nm/420 nm) for 30 seconds. The film thus cured was assessed immediately thereafter for tack with the finger. This assessment was repeated after 2 hours following storage at 23° C./50% relative humidity.

Subsequently the film was subjected to a cross-cut test in accordance with DIN EN 2409 and to a fingernail test.

The results of these tests are compiled in Table 1.

TABLE 1
Compositions as photocurable coating materials.

| | Ref. 1 | 1 | Ref. 2 | 2 |
|---|---|---|---|---|
| 3-THF-A | | 95% by weight | | |
| THFA¹ | 95% by weight | | | |
| 3-THF-MA | | | | 95% by weight |
| THFMA² | | | 95% by weight | |
| IRGACURE 2022³ | 5% by weight | 5% by weight | 5% by weight | 5% by weight |
| Tack (30 s) | Superficially dry, soft, | Superficially | Tacky | Tacky |
| | fingerprint visible | dry | | |
| Tack (2 h) | Dry | Dry | Dry | Dry |
| Cross-cut | 2 | 0 | 3 | 1 |
| Finger nail test | Scratchable, | Firm, good | Soft, no | Firm, good |
| | can be rubbed off | adhesion | adhesion | adhesion |

¹THFA = tetrahydrofurfuryl acrylate
²THFMA = tetrahydrofurfuryl methacrylate
³IRGACURE 2022, Ciba Specialty Chemicals.

Exemplary Compositions as Adhesive

Two-component compositions in accordance with Table 2 were prepared as follows:

Component K1: The liquid rubber was dissolved in the monomer, the catalyst was added and the composition was mixed, with stirring, with the core-shell polymer and the filler, and deaerated under reduced pressure. The resulting paste was dispensed 1:10 into the large chamber of a coaxial twin cartridge, and tightly sealed.

Component K2: Dibenzoyl peroxide, plasticizer and filler were intimately mixed with one another so as to give a paste. This paste was dispensed 1:10 into the small chamber of a coaxial twin cartridge, and tightly sealed.

The 2-component cartridges produced in this way were stored at 23° C./50% relative humidity and used within 24 hours for the measurements.

Test Methods:

To characterize the mechanical properties and adhesive bonds, the compositions in accordance with Table 2 were mixed in a 10:1 volume ratio.

The tensile strength (“TS”) was determined in accordance with ISO 527 at 23° C.

The elongation at break (“EB”) was determined in accordance with ISO 527 at 23° C.

The tensile shear strength (“TSS”) was determined in a method based on ISO 4587/DIN EN 1465 on a Zwick/Roell Z005 tensile machine (bond area:12 mm×25 mm, film thickness: 1.5 mm, measuring speed: 10 mm/min, substrates: aluminium (100 mm×25 mm×2 mm), PVC, ABS, polycarbonate (PC), temperature: 23° C. (unless specified otherwise), pre-treatment: Sika DADPrep (Sika Schweiz AG)).

Using a torsional pendulum, in accordance with DIN EN 61006, the glass transition temperature (“Tg”) was determined and, in accordance with DIN EN ISO 6721-2, the storage modulus (“G′”) was determined.

The results are reported in Table 2.

TABLE 2
Compositions as adhesives.

| | 3 | Ref. 3 | Ref. 4 | Ref. 5 | Ref. 6 | Ref. 7 | 4 | Ref. 8 |
|---|---|---|---|---|---|---|---|---|
| K1 | | | | | | | | |
| 3-THF-MA [pbw]¹ | 58 | | | | | | 49 | |
| THFMA [pbw]¹ | | 58 | | | | | | 49 |
| HEMA [pbw]¹ | | | 58 | | | | | |
| CHMA [pbw]¹ | | | | 58 | | | | |
| TMCHMA [pbw]¹ | | | | | 58 | | | |
| IBMA [pbw]¹ | | | | | | 58 | | |
| N,N-Dimethyl-p-toluidine [pbw]¹ | 1 | 1 | 1 | 1 | 1 | 1 | 1 | 1 |
| Hycar ® VTBNX [pbw]¹ | 15 | 15 | 15 | 15 | 15 | 15 | 15 | 15 |
| Core-Shell polymer [pbw]¹ | 10.5 | 10.5 | 10.5 | 10.5 | 10.5 | 10.5 | 10 | 10 |
| Zinc di(methacrylate) [pbw]¹ | | | | | | | 10 | 10 |
| Mineral filler [pbw]¹ | 15.5 | 15.5 | 15.5 | 15.5 | 15.5 | 15.5 | 15 | 15 |
| K2 | | | | | | | | |
| Dibenzoyl peroxide [pbw]¹ | 10 | 10 | 10 | 10 | 10 | 10 | 10 | 10 |
| Plasticizer [pbw]¹ | 30 | 30 | 30 | 30 | 30 | 30 | 30 | 30 |
| Mineral filler [pbw]¹ | 60 | 60 | 60 | 60 | 60 | 60 | 60 | 60 |
| Odour | little | little | none | intense | moderate | strong | little | little |
| TS [MPa] | 24.4 | 11.9 | 16.8 | 22.7 | 17.1 | 10.2 | 29.4 | 19.4 |
| EB [%] | 12 | 211 | 23 | 7 | 5 | 1 | 5 | 25 |
| Tg [° C.] | 80 | 48 | 113 | 71 | 79 | 111 | 98 | 71 |
| G′(80° C.) [MPa] | 10 | 1 | 15 | 3 | 5 | 120 | 103 | 14 |
| TSS (Al, 23° C.) [MPa] | 14 | 12 | 17 | 13 | 9 | 8 | 12 | 13 |
| TSS (Al, 80° C.) [MPa] | 7 | 2 | 9 | 7 | 6 | 10 | 9 | 5 |
| TSS (PVC, 23° C.) [MPa] | 8 | 11 | 1 | 3 | 2 | 2 | 4 | 7 |
| TSS (ABS, 23° C.) [MPa] | 6 | 8 | 5 | 1 | 1 | 1 | 5 | 5 |
| TSS (PC, 23° C.) [MPa] | 8 | 10 | 0 | 1 | 1 | 1 | 4 | 5 |

¹pbw = parts by weight.

1. Single- or multiple-component, free-radically curable composition comprising
at least one free-radically polymerizable monomer of the formula (I) 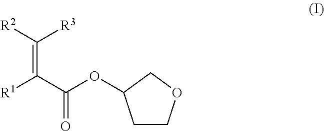
and at least one free-radical initiator,
where R¹ is H, CH₃, CH₂—CH₃ or CH₂COOR⁴,
R² is H, CH₃, CH₂—CH₃, phenyl, CH═CH—CH₃, COOR⁴ or CH₂COOR⁴, and
R³ is H, CH₃, COOR⁴ or CH₂COOR⁴
where R⁴ is H, alkyl, cycloalkyl, phenyl or

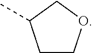

2. Single- or multiple-component, free-radically curable composition according to claim 1, R²═R³═H and R¹ is H or CH₃.

3. Single- or multiple-component, free-radically curable composition according to claim 1, wherein the composition additionally comprises at least one further free-radically polymerizable monomer M.

4. Single- or multiple-component, free-radically curable composition according to claim 3, wherein least one further free-radically polymerizable monomer M is selected from the group consisting of α,β-unsaturated carboxylic acids, esters of α,β-unsaturated carboxylic acids, amides of α,β-unsaturated carboxylic acids, anhydrides of α,β-unsaturated carboxylic acids; α,β-unsaturated dicarboxylic acids, esters of α,β-unsaturated dicarboxylic acids, amides of α,β-unsaturated dicarboxylic acids, anhydrides of α,β-unsaturated dicarboxylic acids; vinyl alcohols or allyl alcohols; vinylcarboxylic esters, allylcarboxylic esters, acrylonitrile and styrene.

5. Single- or multiple-component, free-radically curable composition according to claim 4, wherein at least one further free-radically polymerizable monomer M is (meth)acrylic acid or a (meth)acrylic ester.

6. Single- or multiple-component, free-radically curable composition according to claim 4, wherein at least one further free-radically polymerizable monomer M is selected from the group consisting of 2-hydroxyethyl methacrylate (HEMA), 2-hydroxypropyl methacrylate (HPMA), trimethylcyclohexyl methacrylate (TMCHMA), cyclohexyl methacrylate (CHMA), isobornyl methacrylate (IBMA), tetrahydrofurfuryl methacrylate (THFMA), more particularly tetrahydrofurfuryl methacrylate (THFMA).

7. Single- or multiple-component, free-radically curable composition according to claim 1, wherein the composition further comprises at least one metal (meth)acrylate.

8. Single- or multiple-component, free-radically curable composition according to claim 7, wherein the metal (meth)acrylate is a metal (meth)acrylate of Ca(II), Mg(II) or Zn(II) and contains hydroxy and/or (meth)acrylic acid or (meth)acrylate as ligand or anion.

9. Single- or multiple-component, free-radically curable composition according to claim 1, wherein the free-radical initiator is a peroxide, a perester or hydroperoxide.

10. Single- or multiple-component, free-radically curable composition according to claim 9, wherein the free-radical initiator is a dibenzoyl peroxide.

11. Single- or multiple-component, free-radically curable composition according to claim 9, wherein the composition further comprises at least one tertiary amine or transition metal salt or transition metal complex as catalyst.

12. Single- or multiple-component, free-radically curable composition according to claim 9, wherein the free-radically curable composition is two-component and is composed of a first component K1 and a second component K2,
the first component K1 comprising at least the free-radically polymerizable monomer of the formula (I) and, if desired, the tertiary amine as activator; and the second component K2 comprising at least the peroxide, the perester or the hydroperoxide as free-radical initiator.

13. Single- or multiple-component, free-radically curable composition according to claim 1, wherein the free-radical initiator is a photoinitiator.

14. Single- or multiple-component, free-radically curable composition according to claim 13, wherein the photoinitiator is a photoinitiator which forms free radicals on irradiation with an electromagnetic radiation of the wavelength of 230 nm to 400 nm.

15. Single- or multiple-component, free-radically curable composition according to claim 14, wherein the photoinitiator is liquid at room temperature.

16. Single- or multiple-component, free-radically curable composition according to claim 15, wherein the photoinitiator is selected from the group consisting of α-hydroxyketones, phenylglyoxylates, monoacylphosphines, diacylphosphines, phosphine oxides and mixtures thereof.

17. Single- or multiple-component, free-radically curable composition according to claim 16, wherein the photoinitiator is a combination of a bisacylphosphine oxide and an α-hydroxyketone.

18. Single- or multiple-component, free-radically curable composition according to claim 13, wherein the free-radically curable composition is one-component.

19. (canceled)

20. (canceled)

21. Method of adhesively bonding substrates S1 and S2, comprising the steps of
i) applying the single- or multiple-component, free-radically curable composition according to claim 1 to a substrate S1;
ii) contacting the applied composition with a second substrate S2 within the open time;
or
ia) applying the single- or multiple-component, free-radically curable composition according to claim 1 to a substrate S1;
ib) applying the single- or multiple-component, free-radically curable composition according to claim 1 to a substrate S2;
iia) joining the two substrates S1 and S2, with composition applied, within the open time;
the second substrate S2 being composed of the same material as or a different material from the substrate S1; and
step i), or ia) and ib), in the case of a multiple-component composition, being preceded by a step I) of at least partly mixing the plurality of components.

22. Method of coating a substrate S1, comprising the steps of
i′) applying a single- or multiple-component, free-radically curable composition according to claim 1 to a substrate S1
ii′) curing the single- or multiple-component, free-radically curable composition.

23. Method according to claim 22, wherein the single- or multiple-component, free-radically curable composition comprises at least one free-radically polymerizable monomer of the formula (I) 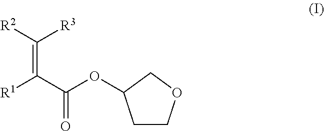
and at least one free-radical initiator,
where R¹ is H, CH₃, CH₂—CH₃ or CH₂COOR⁴,
R² is H, CH₃, CH₂—CH₃, phenyl, CH═CH—CH₃, COOR⁴ or CH₂COOR⁴, and
R³ is H, CH₃, COOR⁴ or CH₂COOR⁴
where R⁴ is H, alkyl, cycloalkyl, phenyl or 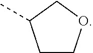
wherein the free-radical initiator is a photoinitiator and step i′) is followed by a step i″) of irradiating the composition with an electromagnetic radiation.

24. Adhesively bonded article produced by means of a method of adhesive bonding according to claim 21.

25. Coated article produced by means of a method of coating according to claim 22.

26. Cured composition wherein it is obtained from a single- or multiple-component, free-radically curable composition according to claim 1 by a curing operation.

27. (canceled)

28. (canceled)
